(19) United States
(12) Patent Application Publication
(10) Pub. No.: US 2007/0222095 A1
(43) Pub. Date: Sep. 27, 2007

(54) PROCESS FOR MAKING OPHTHALMIC LENSES

(76) Inventors: Diana Zanini, Jacksonville, FL (US); James D. Ford, Orange Park, FL (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/427,582

(22) Filed: Jun. 29, 2006

Related U.S. Application Data
(63) Continuation-in-part of application No. 11/387,250, filed on Mar. 23, 2006.

(51) Int. Cl. B29D 11/00

(52) U.S. Cl. 264/1.32; 264/2.6; 264/236; 264/342 R; 264/331.11

(57) ABSTRACT

The present invention relates to aqueous processes for the production of silicone hydrogel contact lenses.

### FIELD OF THE INVENTION

This invention relates to aqueous processes for making silicone hydrogel contact lenses.

### BACKGROUND OF THE INVENTION

It is known that contact lenses can be used to improve vision, and various contact lenses have been commercially produced for many years. Hydrogel contact lenses are very popular today. These lenses are often more comfortable to wear than contact lenses made of hard materials. Malleable soft contact lenses can be manufactured by forming a lens in a multi-part mold where the combined parts form a topography consistent with the desired final lens. Contact lenses made from silicone hydrogels have been disclosed.

Multi-part molds used to fashion hydrogels into useful articles, such as ophthalmic lenses, can include for example, a first mold portion with a convex surface that corresponds with a back curve of an ophthalmic lens and a second mold portion with a concave surface that corresponds with a front curve of the ophthalmic lens. To prepare a lens using such mold portions, an uncured hydrogel lens formulation is placed between the concave and convex surfaces of the mold portions and subsequently cured. The hydrogel lens formulation may be cured, for example by exposure to either, or both, heat and light. The cured hydrogel forms a lens according to the dimensions of the mold portions.

Following cure, the mold portions are separated and the lens remains adhered to one of the mold portions. A release process detaches the lens from the remaining mold part. Release of the lens from the mold has been facilitated by exposure of the lens to varions solutions which act to swell the lens and loosen adhesion of the lens to the mold.

New developments in the field have led to contact lenses that are made from silicone hydrogels. Known hydration processes using aqueous solutions to effect release have not been efficient with silicone hydrogel lenses. Consequently, attempts have been made to release silicone lenses using organic solvents. Processes have been described in which a lens is immersed in an alcohol, ketone, aldehyde, ester, amide or N-alkyl pyrrolidone for 20 hours-40 hours and in the absence of water, or in an admixture with water as a minor component.

However, although some success has been realized with the known processes, the use of highly concentrated organic solutions can present drawbacks, including, for example: safety hazards; increased risk of down time to a manufacturing line; high cost of release solution; and the possibility of collateral damage, due to explosion.

Therefore, it would be advantageous to find a method of producing a silicone hydrogel contact lens which requires the use of little or no organic solvent, avoids the use of flammable agents, that effectively releases lenses from the molds in which they were formed.

### SUMMARY OF THE INVENTION

The present invention relates to a process comprising a method comprising
(a) curing a reactive mixture comprising at least one silicone containing component and at least one shrinkage agent in a mold to form a cured article;
(b) hydrating the cured article in the mold under conditions which shrink the cured article; and
(c) optionally removing the cured article from the mold.

In another embodiment the present invention relates to a method comprising
(a) curing in a mold to form a silicone hydrogel contact lens, a reaction mixture comprising at least one reactive silicone component and at least about 40 weight % diluent based upon all components in the reaction mixture;
(b) contacting the contact lens with an aqueous solution in the mold under conditions which shrink the contact lens; and
(c) optionally removing the contact lens from the mold.

### DESCRIPTION OF THE FIGURE

FIG. 1 is a diagram of an ophthalmic lens and mold parts used to form the ophthalmic lens.

### DETAILED DESCRIPTION OF THE INVENTION

It has been found that the release of silicone hydrogel cast molded parts using aqueous solutions may be facilitated by including at least one shrink agent in the reactive mixture which is used to form the silicone hydrogel part. Surprisingly, reaction mixtures have been found which contain shrink agents in amounts suitable to provide desirable release conditions, but still provide a lens polymer with desirable modulus and water content.

As used herein, “at least one shrink agent” means at least one component which, when included in a release effective amount, causes the silicone part to release from at least a portion of the mold in which is was cast when the mold and part are are exposed to at least one release process condition. Examples of process conditions which may cause shrinkage include temperature, pH, ionicity, hydrophilicity, combinations thereof and the like. In one embodiment, the release process condition comprises contact with at least one aqueous solution. As used herein, a “release effective amount” means an amount sufficient to cause release in less than about 60 minutes, in some embodiments, less than about 10 minutes, in other embodiments less than about 6 minutes, and in other embodiments less than about 2 minutes.

As used herein, “released from a mold,” means that a lens is either completely separated from the mold, or is only loosely attached so that it can be removed with mild agitation or mild manipulation, such as by vacuum assist, manual or automated manipulation, such as swabbing, or any combination thereof.

Generally, shrink agents cause the molded part to shrink when the molded part and mold are contacted with an aqueous solution. Shrinkage of at least about 3% has been found to be sufficient to cause release of the molded part from the mold. In some embodiments the shrinkage is at least about 5%, and in other embodiments at least about 7%. Percent shrinkage can be measured by forming the desired molded article from the reactive mixture with the shrinkage agent(s), measuring the diameter of the mold (mold dia) and the resulting lenses at the conditions to be used for release (lens dia_{w/agent}) and calculating as follows:

% shrinkage=[(mold dia−lens dia_{w/agent})/Imold dia]×100.

### The diameters may be measured using a VanKeuren, Varibeam, “shadowgraph” equipped with Mitutoyo calipers.

Formulations which provide higher amounts of shrinkage allow for processing at milder release conditions. Mold materials may also impact the amount of shrinkage desired to effect release.

As used herein “reactive mixture” refers to the reactive components and diluent used to form the lens. The reactive components include silicone containing components, hydrophilic monomers, lubricious polymers, photoinitiators and other components which when reacted form the lens.

In one embodiment, suitable shrink agents include components which, when included in a reaction mixture, increase modulus, decrease water content or both of the resulting polymer. Examples of these shrink agents include, but are not limited to crosslinkers; low molecular weight monofunctional silicones, water content decreasing components, combinations thereof and the like. The desired amount of shrinking may also be achieved by increasing the amount of diluent used to form the reactive mixture. Each of these shrink agents is described in detail, below.

Crosslinkers are compounds with two or more polymerizable groups. As used herein, “polymerizable groups” are groups which are reactive under the polymerization conditions to which the reaction mixture is subjected. Generally suitable reactive groups include free radical reactive groups comprising acrylate, styryl, vinyl, vinyl ether, itaconate group, acrylamide, N-vinyllactam, N-vinylamide, or a cationic reactive group such as vinyl ether or epoxide groups, and the like. (Meth)acrylate groups are commonly used. As used herein, the term “(meth)” designates optional methyl substitution. Thus, a term such as “(meth)acrylate” denotes both methacrylic and acrylic radicals. The crosslinkers may be hydrophilic or hydrophobic. Generally, in the present invention amounts of crosslinkers of at least about 2 mole %, in some embodiments at least about 2.5 mole % and in others at least about 3 mole % have been found effective in providing the desired amount of shrinkage. Crosslinkers are also known to impact the modulus of the resulting polymer. Generally moduli of less than about 200 psi, in some embodiments less than about 150 psi and in other less than about 125 psi are desirable. Accordingly, the amount of crosslinker used should be selected to produce polymers having moduli below the limits specified herein. For some embodiments, it may be desirable to use a combination of shrink agents to get the desired percent shrinkage without increasing modulus above desired ranges.

Examples of suitable hydrophilic crosslinkers include compounds having two or more polymerizable groups, as well as hydrophilic functional groups such as polyether, amide or hydroxyl groups. Specific examples of hydrophilic crosslinkers include, but are not limited to tetraethyleneglycol dimethacrylate (TEGDMA), triethyleneglycol dimethacrylate (TrEGDMA), ethyleneglycol dimethacylate (EGDMA), ethylenediamine dimethyacrylamide, glycerol dimethacrylate and combinations thereof.

Hydrophobic crosslinkers may also be used. Examples of suitable hydrophobic crosslinkers include multifunctional hydroxyl-functionalized silicone containing monomer, multifunctional polyether-polydimethylsiloxane block copolymers, combinations thereof and the like. Specific hydrophobic crosslinkers include acryloxypropyl terminated polydimethylsiloxane (n=10 or 20) (acPDMS), hydroxylacrylate functionalized siloxane macromer, methacryloxypropyl terminated PDMS, butanediol dimethacrylate, divinyl benzene, 1,3-bis(3-methacryloxypropyl)tetrakis(trimethylsiloxy) disiloxane and mixtures thereof.

Preferred crosslinkers include TEGDMA, EGDMA, acPDMS and combinations thereof.

The shrink agent may also comprise at least one monofunctional low molecular weight silicone. Suitable monofunctional low molecular weight silicones comprise one polymerizable group, at least one siloxane and molecular weights of less than about 1000, in some embodiments less than about 800, and in other embodiments less than about 700. The siloxane group may be terminal, such as mono, bis and tri(trialkylsiloxy)silane, or may be linear, such as in polyalkylsiloxanes, such as polydimethylsiloxane. Specific examples of suitable monofunctional low molecular weight silicones include, but are not limited to monomethacryloxypropyl terminated mono-n-butyl terminated polydimethylsiloxanes (mPDMS), 2-methyl-,2-hydroxy-3-[3-[1,3,3,3-tetramethyl-1-[(trimethylsilyl)oxy]disiloxanyl]propoxy]propyl ester (“SiGMA”), 2-hydroxy-3-methacryloxypropyloxypropyl-tris(trimethylsiloxy)silane, 3-methacryloxypropyltris(trimethylsiloxy)silane (“TRIS”), 3-methacryloxypropylbis(trimethylsiloxy)methylsilane and 3-methacryloxypropylpentamethyl disiloxane, mono-(3-methacryloxy-2-hydroxypropyloxy)propyl terminated, mono-butyl terminated polydimethylsiloxane, silicone containing methacrylamide monomers such as those disclosed in US2005-0176911, the disclosure of which is incorporated herein by reference, combinations thereof and the like.

When the monofunctional low molecular weight silicones replace silicones having molecular weights greater than about 1000, release is improved. In some embodiments a release effective amount of monofunctional low molecular weight silicone is at least about 10 weight % of the silicones having a molecular weight greater than about 1000 is replaced with at least one monofunctional low molecular weight silicone, and in some embodiments between about 20 and about 100 weight %; and in others between about 40 and about 100 weight % of the silicones having a molecular weight greater than about 1000 is replaced with at least one monofunctional low molecular weight silicone.

Alternatively, or in addition to the shrink agents described above, the shrink agent may comprise at least one water content decreasing compound (“WCD compound”). Suitable WCD compounds decrease the water content of the polymer in which they are incorporated. In some embodiments the WCD compounds are incorporated in amounts sufficient to provide a decrease in water content of at least about 1%, and in other embodiments at least about 2%, compared to a composition without that amount of WCD compound. Suitable WCD compounds are non-silicone containing compounds which are less hydrophilic than the components in the reaction mixture which they replace. For example, comparing Examples 1 and 5, in Example 5, 4.5 weight % N,N-dimethylacrylamide (DMA) is replaced with 2-hydroxyethylmethacrylate (HEMA). When the proportion of HEMA used in relation to more hydrophilic components, such as N,N-dimethylacrylamide, is increased, release time is decreased, particularly when other release agents are also included. The relative contribution to water content of various contact lens forming components are generally known in the art, and other suitable WCD compounds will be apparent to those of skill in the art using the teachings herein.

The amount of diluent used in the reaction mixture will also impact release, with higher amounts of diluent decreasing release time. When high amounts of other release agents are present (for example amounts of shrink agent that provide 4% or more shrinkage), the amount of diluent may be less than about 45% or even 40% by weight of the reaction mixture. However, when lower amounts of other shrink agents are present (amounts that provide less than 4% shrinkage) the amount of diluent may be between about 45 and about 60% by weight, based upon the weight of the reaction mixture.

As has been noted above, the effects of the various shrink agents can be additive, and formulations with both good release and good polymer properties may be made by incorporating more than one shrink agent. For example, if a water content greater than about 40% were desired, non-silicone containing crosslinkers such as TEDGMA in amounts of about 2 mole % and diluent levels of about 55 weight % could be used. Other combinations of shrink agents will be apparent to those of skill in the art based upon the teaching herein.

The shrink agents are incorporated into the reaction mixture with the reactive components. Any reactive components suitable for making a silicone hydrogel may be included. Suitable components include hydrophilic components, silicone containing components, reactive and non-reactive internal wetting agents, combatibilizing components, reactive and non-reactive colorants, such as tints, dyes, pigments, UV absorbing compounds, and other ophthalmic additives, such as, but not limited to photochromic compounds, therapeutic and nutriceutical ophthalmic additives, such as ophthalmic pharmaceuticals, antimicrobial compounds, antifungal compounds, stabilizers, antioxidants, combinations thereof and the like. It is a feature of the present invention that release in aqueous solutions may be achieved without sacrificing desirable lens properties. For example, in one embodiment, silicone hydrogel contact lenses having the following properties may be produced:

oxygen permeabilities≧about 50 barrer and in some embodiments≧about 100 barrer;

moduli≦150 psi and in some embodiments≦100 psi;

water content>30% and in some embodiments>40%.

In some embodiments the articles produced have more than one of the above listed properties.

The reactive mixtures of the present invention comprise at least one silicone containing component.

The term component includes monomers, macromers and prepolymers. “Monomer” refers to lower molecular weight compounds that can be polymerized to higher molecular weight compounds, polymers, macromers, or prepolymers. The term “macromer” as used herein refers to a high molecular weight polymerizable compound. Prepolymers are partially polymerized monomers or monomers which are capable of further polymerization.

A “silicone-containing component” is one that contains at least one [—Si—O—] unit in a monomer, macromer or prepolymer. Preferably, the total Si and attached O are present in the silicone-containing component in an amount greater than about 20 weight percent, and more preferably greater than 30 weight percent of the total molecular weight of the silicone-containing component. Useful silicone-containing components preferably comprise polymerizable functional groups such as acrylate, methacrylate, acrylamide, methacrylamide, vinyl, N-vinyl lactam, N-vinylamide, and styryl functional groups. Examples of silicone-containing components which are useful in this invention may be found in U.S. Pat. Nos. 3,808,178; 4,120,570; 4,136,250; 4,153,641; 4,740,533; 5,034,461 and 5,070,215, and EP080539. These references disclose many examples of olefinic silicone-containing components.

Suitable silicone containing components include compounds of Formula I

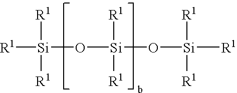

where

R¹ is independently selected from monovalent reactive groups, monovalent alkyl groups, or monovalent aryl groups, any of the foregoing which may further comprise functionality selected from hydroxy, amino, oxa, carboxy, alkyl carboxy, alkoxy, amido, carbamate, carbonate, halogen or combinations thereof; and monovalent siloxane chains comprising 1-100 Si—O repeat units which may further comprise functionality selected from alkyl, hydroxy, amino, oxa, carboxy, alkyl carboxy, alkoxy, amido, carbamate, halogen or combinations thereof;

where b=0 to 500, where it is understood that when b is other than 0, b is a distribution having a mode equal to a stated value;

wherein at least one R¹ comprises a monovalent reactive group, and in some embodiments between one and 3 R¹ comprise monovalent reactive groups.

As used herein “monovalent reactive groups” are groups that can undergo free radical and/or cationic polymerization. Non-limiting examples of free radical reactive groups include (meth)acrylates, styryls, vinyls, vinyl ethers, C₁₋₆alkyl(meth)acrylates, (meth)acrylamides, C₁₋₆alkyl(meth)acrylamides, N-vinyllactams, N-vinylamides, C₂₋₁₂alkenyls, C₂₋₁₂alkenylphenyls, C₂₋₁₂alkenylnaphthyls, C₂₋₆alkenylphenylC₁₋₆alkyls, O-vinylcarbamates and O-vinylcarbonates. Non-limiting examples of cationic reactive groups include vinyl ethers or epoxide groups and mixtures thereof. In one embodiment the free radical reactive groups comprises (meth)acrylate, acryloxy, (meth)acrylamide, and mixtures thereof.

Suitable monovalent alkyl and aryl groups include unsubstituted monovalent C₁ to C₁₆alkyl groups, C₆-C₁₄ aryl groups, such as substituted and unsubstituted methyl, ethyl, propyl, butyl, 2-hydroxypropyl, propoxypropyl, polyethyleneoxypropyl, combinations thereof and the like.

In one embodiment b is zero, one R¹ is a monovalent reactive group, and at least 3 R¹ are selected from monovalent alkyl groups having one to 16 carbon atoms, and in another embodiment from monovalent alkyl groups having one to 6 carbon atoms. Non-limiting examples of silicone components of this embodiment include 2-methyl-,2-hydroxy-3-[3-[1,3,3,3-tetramethyl-1-[(trimethylsilyl)oxy]disiloxanyl]propoxy]propyl ester (“SiGMA”), 2-hydroxy-3-methacryloxypropyloxypropyl-tris(trimethylsiloxy)silane, 3-methacryloxypropyltris(trimethylsiloxy)silane (“TRIS”), 3-methacryloxypropylbis(trimethylsiloxy)methylsilane and 3-methacryloxypropylpentamethyl disiloxane.

In another embodiment, b is 2 to 20, 3 to 15 or in some embodiments 3 to 10; at least one terminal R¹ comprises a monovalent reactive group and the remaining R¹ are selected from monovalent alkyl groups having 1 to 16 carbon atoms, and in another embodiment from monovalent alkyl groups having 1 to 6 carbon atoms. In yet another embodiment, b is 3 to 15, one terminal R¹ comprises a monovalent reactive group, the other terminal R¹ comprises a monovalent alkyl group having 1 to 6 carbon atoms and the remaining R¹ comprise monovalent alkyl group having 1 to 3 carbon atoms. Non-limiting examples of silicone components of this embodiment include (mono-(2-hydroxy-3-methacryloxypropyl)-propyl ether terminated polydimethylsiloxane (400-1000 MW)) (“OH-mPDMS”), monomethacryloxypropyl terminated mono-n-butyl terminated polydimethylsiloxanes (800-1000 MW), (“mPDMS”).

In another embodiment b is 5 to 400 or from 10 to 300, both terminal R¹ comprise monovalent reactive groups and the remaining R¹ are independently selected from monovalent alkyl groups having 1 to 18 carbon atoms which may have ether linkages between carbon atoms and may further comprise halogen.

In another embodiment, one to four R¹ comprises a vinyl carbonate or carbamate of the formula:

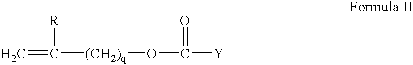

wherein: Y denotes O—, S— or NH—; R denotes, hydrogen or methyl; d is 1, 2, 3 or 4; and q is 0 or 1.

The silicone-containing vinyl carbonate or vinyl carbamate monomers specifically include: 1,3-bis[4-(vinyloxycarbonyloxy)but-1-yl]tetramethyl-disiloxane; 3-(vinyloxycarbonylthio) propyl-[tris(trimethylsiloxy)silane]; 3-[tris(trimethylsiloxy)silyl]propyl allyl carbamate; 3-[tris(trimethylsiloxy)silyl]propyl vinyl carbamate; trimethylsilylethyl vinyl carbonate; trimethylsilylmethyl vinyl carbonate, and

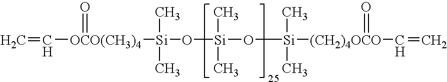

Where biomedical devices with modulus below about 200 are desired, only one R¹ shall comprise a monovalent reactive group and no more than two of the remaining R¹ groups will comprise monovalent siloxane groups.

In one embodiment, where a silicone hydrogel lens is desired, the lens of the present invention will be made from a reactive mixture comprising at least about 20 and preferably between about 20 and 70% wt silicone containing components based on total weight of reactive monomer components from which the polymer is made.

Another class of silicone-containing components includes polyurethane macromers of the following formulae: Formulae IV-VI

(*D*A*D*G)ₐ*D*D*E¹;

E(*D*G*D*A)ₐ*D*G*D*E¹ or;

E(*D*A*D*G)ₐ*D*A*D*E¹

wherein:

D denotes an alkyl diradical, an alkyl cycloalkyl diradical, a cycloalkyl diradical, an aryl diradical or an alkylaryl diradical having 6 to 30 carbon atoms,

G denotes an alkyl diradical, a cycloalkyl diradical, an alkyl cycloalkyl diradical, an aryl diradical or an alkylaryl diradical having 1 to 40 carbon atoms and which may contain ether, thio or amine linkages in the main chain;

* denotes a urethane or ureido linkage;

ₐ is at least 1;

A denotes a divalent polymeric radical of formula:

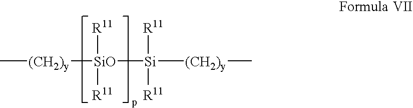

R¹¹ independently denotes an alkyl or fluoro-substituted alkyl group having 1 to 10 carbon atoms which may contain ether linkages between carbon atoms; y is at least 1; and p provides a moiety weight of 400 to 10,000; each of E and E¹ independently denotes a polymerizable unsaturated organic radical represented by formula:

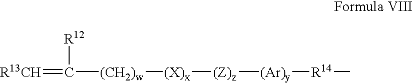

wherein: R¹² is hydrogen or methyl; R¹³ is hydrogen, an alkyl radical having 1 to 6 carbon atoms, or a —CO—Y—R¹⁵ radical wherein Y is —O—, Y—S— or —NH—; R¹⁴ is a divalent radical having 1 to 12 carbon atoms; X denotes —CO— or —OCO—; Z denotes —O— or —NH—; Ar denotes an aromatic radical having 6 to 30 carbon atoms; w is 0 to 6; x is 0 or 1; y is 0 or 1; and z is 0 or 1.

A preferred silicone-containing component is a polyurethane macromer represented by the following formula:

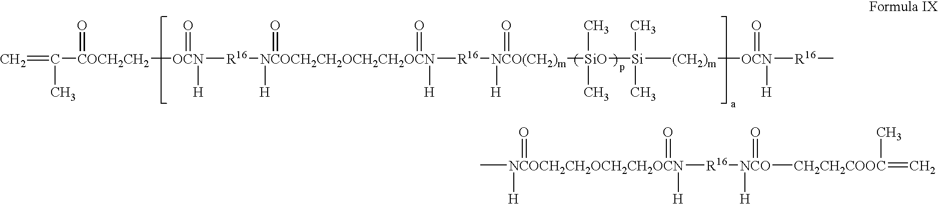

wherein R¹⁶ is a diradical of a diisocyanate after removal of the isocyanate group, such as the diradical of isophorone diisocyanate. Another suitable silicone containing macromer is compound of formula X (in which x+y is a number in the range of 10 to 30) formed by the reaction of fluoroether, hydroxy-terminated polydimethylsiloxane, isophorone diisocyanate and isocyanatoethylmethacrylate.

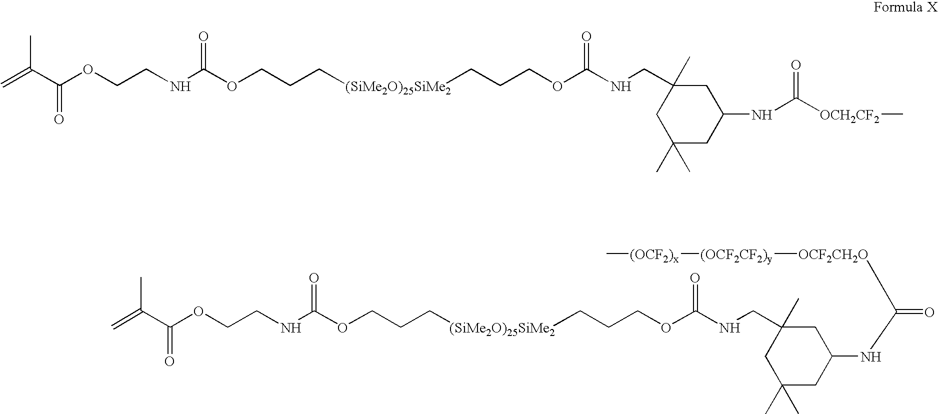

Other silicone containing components suitable for use in this invention include those described is WO 96/31792 such as macromers containing polysiloxane, polyalkylene ether, diisocyanate, polyfluorinated hydrocarbon, polyfluorinated ether and polysaccharide groups. U.S. Pat. Nos. 5,321,108; 5,387,662 and 5,539,016 describe polysiloxanes with a polar fluorinated graft or side group having a hydrogen atom attached to a terminal difluoro-substituted carbon atom. US 2002/0016383 describe hydrophilic siloxanyl methacrylates containing ether and siloxanyl linkanges and crosslinkable monomers containing polyether and polysiloxanyl groups. Any of the foregoing polysiloxanes can also be used as the silicone containing component in this invention.

The reactive mixture may also comprise at least one hydrophilic component. Hydrophilic monomers can be any of the hydrophilic monomers known to be useful to make hydrogels.

One class of suitable hydrophilic monomers include acrylic- or vinyl-containing monomers. Such hydrophilic monomers may themselves be used as crosslinking agents, however, where hydrophilic monomers having more than one polymerizable functional group are used, their concentration should be limited as discussed above to provide a contact lens having the desired modulus. The term “vinyl-type” or “vinyl-containing” monomers refer to monomers containing the vinyl grouping (—CH═CH₂) and are generally highly reactive. Such hydrophilic vinyl-containing monomers are known to polymerize relatively easily.

“Acrylic-type” or “acrylic-containing” monomers are those monomers containing the acrylic group: (CH₂═CRCOX) wherein R is H or CH₃, and X is O or N, which are also known to polymerize readily, such as N,N-dimethyl acrylamide (DMA), 2-hydroxyethyl methacrylate (HEMA), glycerol methacrylate, 2-hydroxyethyl methacrylamide, polyethyleneglycol monomethacrylate, methacrylic acid and acrylic acid.

Hydrophilic vinyl-containing monomers which may be incorporated into the silicone hydrogels of the present invention include monomers such as N-vinyl amides, N-vinyl lactams (e.g. N-vinylpyrrolidone or NVP), N-vinyl-N-methyl acetamide, N-vinyl-N-ethyl acetamide, N-vinyl-N-ethyl formamide, N-vinyl formamide, with NVP being preferred.

Other hydrophilic monomers that can be employed in the invention include polyoxyethylene polyols having one or more of the terminal hydroxyl groups replaced with a functional group containing a polymerizable double bond. Examples include polyethylene glycol, ethoxylated alkyl glucoside, and ethoxylated bisphenol A reacted with one or more molar equivalents of an end-capping group such as isocyanatoethyl methacrylate (“IEM”), methacrylic anhydride, methacryloyl chloride, vinylbenzoyl chloride, or the like, to produce a polyethylene polyol having one or more terminal polymerizable olefinic groups bonded to the polyethylene polyol through linking moieties such as carbamate or ester groups.

Still further examples are the hydrophilic vinyl carbonate or vinyl carbamate monomers disclosed in U.S. Pat. No. 5,070,215, and the hydrophilic oxazolone monomers disclosed in U.S. Pat. No. 4,910,277. Other suitable hydrophilic monomers will be apparent to one skilled in the art.

In one embodiment the hydrophilic monomer comprises at least one of DMA, HEMA, glycerol methacrylate, 2-hydroxyethyl methacrylamide, NVP, N-vinyl-N-methyl acrylamide, N-methyl-N-vinylacetamide, polyethyleneglycol monomethacrylate, methacrylic acid and acrylic acid, In one embodiment the hydrophilic monomer comprises DMA.

The hydrophilic monomers may be present in a wide range of amounts, depending upon the specific balance of properties desired. Amounts of hydrophilic monomer up to about 50 and preferably between about 5 and about 50 weight %, based upon all components in the reactive components are acceptable. For example, in one embodiment lenses of the present invention comprise a water content of at least about 30%, and in another embodiment between about 30 and about 70%. For these embodiments, the hydrophilic monomer may be included in amounts between about 20 and about 50 weight %.

Other components such as reactive and non-reactive wetting agents disclosed in US2003/0162862, US05/06640, US2006/0072069, WO2006/039276 may also be included. When wetting agents are used it may also be desirable to include a compatibilizing component. Suitable compatiblizing components include those meeting the compatibility test disclosed in US2003/0162862. Any of the silicone components described above may be converted into compatibilizing components by incorporating compatibilizing groups, such as hydroxyl groups, in their structure. In some embodiments, the Si to OH ratio is less than about 15:1, and in others between about 1:1 to about 10:1. Non-limiting examples of compatibilizing components include (mono-(2-hydroxy-3-methacryloxypropyl)-propyl ether terminated polydimethylsiloxane (400-1000 MW)), “OH-mPDMS”, 2-methyl-,2-hydroxy-3-[3-[1,3,3,3-tetramethyl-1-[(trimethylsilyl)oxy]disiloxanyl]propoxy]propyl ester “SiGMA”, 2-hydroxy-3-methacryloxypropyloxypropyl-tris(trimethylsiloxy)silane, combinations thereof and the like.

A polymerization catalyst may be included in the reaction mixture. The polymerization initiators includes compounds such as lauryl peroxide, benzoyl peroxide, isopropyl percarbonate, azobisisobutyronitrile, and the like, that generate free radicals at moderately elevated temperatures, and photoinitiator systems such as aromatic alpha-hydroxy ketones, alkoxyoxybenzoins, acetophenones, acylphosphine oxides, bisacylphosphine oxides, and a tertiary amine plus a diketone, mixtures thereof and the like. Illustrative examples of photoinitiators are 1-hydroxycyclohexyl phenyl ketone, 2-hydroxy-2-methyl-1-phenyl-propan-1-one, bis(2,6-dimethoxybenzoyl)-2,4-4-trimethylpentyl phosphine oxide (DMBAPO), bis(2,4,6-trimethylbenzoyl)-phenyl phosphineoxide (Irgacure 819), 2,4,6-trimethylbenzyldiphenyl phosphine oxide and 2,4,6-trimethylbenzoyl diphenylphosphine oxide, benzoin methyl ester and a combination of camphorquinone and ethyl 4-(N,N-dimethylamino)benzoate. Commercially available visible light initiator systems include Irgacure 819, Irgacure 1700, Irgacure 1800, Irgacure 819, Irgacure 1850 (all from Ciba Specialty Chemicals) and Lucirin TPO initiator (available from BASF). Commercially available UV photoinitiators include Darocur 1173 and Darocur 2959 (Ciba Specialty Chemicals). These and other photoinitators which may be used are disclosed in Volume III, Photoinitiators for Free Radical Cationic & Anionic Photopolymerization, 2^{nd} Edition by J. V. Crivello & K. Dietliker; edited by G. Bradley; John Wiley and Sons; New York; 1998. The initiator is used in the reaction mixture in effective amounts to initiate photopolymerization of the reaction mixture, e.g., from about 0.1 to about 2 parts by weight per 100 parts of reactive monomer. Polymerization of the reaction mixture can be initiated using the appropriate choice of heat or visible or ultraviolet light or other means depending on the polymerization initiator used. Alternatively, initiation can be conducted without a photoinitiator using, for example, e-beam. However, when a photoinitiator is used, the preferred initiators are bisacylphosphine oxides, such as bis(2,4,6-trimethylbenzoyl)-phenyl phosphine oxide (Irgacure 819®) or a combination of 1-hydroxycyclohexyl phenyl ketone and bis(2,6-dimethoxybenzoyl)-2,4-4-trimethylpentyl phosphine oxide (DMBAPO), and in another embodiment the method of polymerization initiation is via visible light activation. A preferred initiator is bis(2,4,6-trimethylbenzoyl)-phenyl phosphine oxide (Irgacure 819®).

Suitable diluents have a polarity sufficiently low to solubilize the non-polar components in the reactive mixture at reaction conditions. One way to characterize the polarity of the diluents of the present invention is via the Hansen solubility parameter, δp. In certain embodiments, the δp is less than about 10, and preferably less than about 6. Suitable diluents are further disclosed in U.S. Ser. No. 60/452898 and U.S. Pat. No. 6,020,445.

Classes of suitable diluents include, without limitation, alcohols having 2 to 20 carbons, amides having 10 to 20 carbon atoms derived from primary amines, ethers, polyethers, ketones having 3 to 10 carbon atoms, and carboxylic acids having 8 to 20 carbon atoms. For all solvents, as the number of carbons increase, the number of polar moieties may also be increased to provide the desired level of water miscibility. In some embodiments, primary and tertiary alcohols are preferred. Preferred classes include alcohols having 4 to 20 carbons and carboxylic acids having 10 to 20 carbon atoms.

In some embodiments, the diluent has some degree of solubility in water. In some embodiments at least five percent of the diluent is miscible water. Examples of water soluble diluents include 1-decanol, 1-octanol, 1-pentanol, 1-hexanol, 2-hexanol, 2-octanol, 3-methyl-3-pentanol, 2-pentanol, t-amyl alcohol, tert-butanol, 2-butanol, 1-butanol, 2-methyl-2-pentanol, 2-ethyl-1-butanol, ethanol, 3,3-dimethyl-2-butanol, decanoic acid, octanoic acid, dodecanoic acid, 1-ethoxy-2- propanol, 1-tert-butoxy-2-propanol, EH-5 (commercially available from Ethox Chemicals), 2,3,6,7-tetrahydroxy-2,3,6,7-tetramethyl octane, 9-(1-methylethyl)-2,5,8,10,13,16-hexaoxaheptadecane, 3,5,7,9,11,13-hexamethoxy-1-tetradecanol, tripropylene glycol methyl ether mixtures thereof and the like.

The reactive mixture of the present invention may be cured via any known process for molding the reaction mixture in the production of contact lenses, including spincasting and static casting. Spincasting methods are disclosed in U.S. Pat. Nos. 3,408,429 and 3,660,545, and static casting methods are disclosed in U.S. Pat. Nos. 4,113,224 and 4,197,266. In one embodiment, the contact lenses of this invention are formed by the direct molding of the silicone hydrogels, which is economical, and enables precise control over the final shape of the hydrated lens. For this method, the reaction mixture is placed in a mold having the shape of the final desired silicone hydrogel, i.e. water-swollen polymer, and the reaction mixture is subjected to conditions whereby the monomers polymerize, to thereby produce a polymer in the approximate shape of the final desired product.

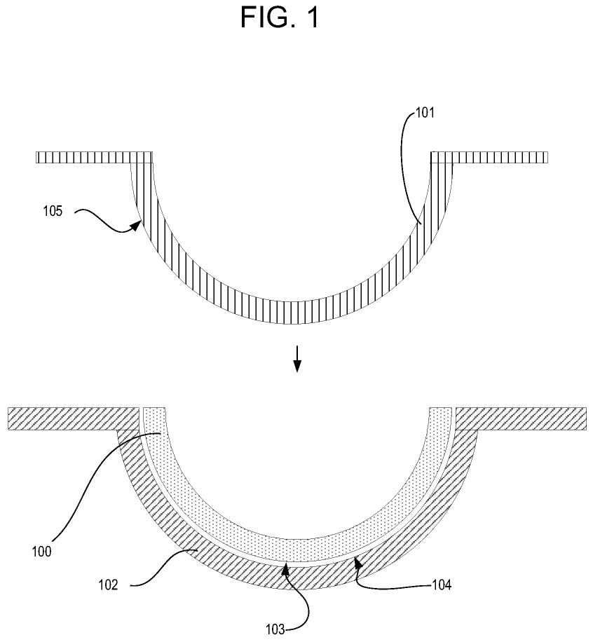

Referring to FIG. 1, a diagram is illustrated of an ophthalmic lens 100, such as a contact lens, and mold parts 101-102 used to form the ophthalmic lens 100. In some embodiments, the mold parts include a back surface mold part 101 and a front surface mold part 102. As used herein, the term “front surface mold part” refers to the mold part whose concave surface 104 is a lens forming surface used to form the front surface of the ophthalmic lens. Similarly, the term “back surface mold part” refers to the mold part 101 whose convex surface 105 forms a lens forming surface, which will form the back surface of the ophthalmic lens 100. In some embodiments, mold parts 101 and 102 are of a concavo-convex shape, preferably including planar annular flanges, which surround the circumference of the uppermost edges of the concavo-convex regions of the mold parts 101-102.

Typically, the mold parts 101-102 are arrayed as a “sandwich”. The front surface mold part 102 is on the bottom, with the concave surface 104 of the mold part facing upwards. The back surface mold part 101 can be disposed symmetrically on top of the front surface mold part 102, with the convex surface 105 of the back surface mold part 101 projecting partially into the concave region of the front surface mold part 102. Preferably, the back surface mold part 101 is dimensioned such that the convex surface 105 thereof engages the outer edge of the concave surface 104 of the front mold part 102 throughout its circumference, thereby cooperating to form a sealed mold cavity in which the ophthalmic lens 100 is formed.

In some embodiments, the mold parts 101-102 are fashioned of thermoplastic and are transparent to polymerization-initiating actinic radiation, by which is meant that at least some, and preferably all, radiation of an intensity and wavelength effective to initiate polymerization of the reaction mixture in the mold cavity can pass through the mold parts 101-102.

For example, thermoplastics suitable for making the mold parts can include: polystyrene; polyvinylchloride; polyolefin, such as polyethylene and polypropylene; copolymers or mixtures of styrene with acrylonitrile or butadiene, polyacrylonitrile, polyamides, polyesters, cyclic olefin copolymers, or other known material.

Following polymerization of the reaction mixture to form a lens 100, the lens surface 103 will typically adhere to the mold part surface 104. The steps of the present invention facilitate release of the surface 103 from the mold part surface.

The first mold part 101 can be separated from the second mold part 102 in a demolding process. In some embodiments, the lens 100 will have adhered to the second mold part 102 (i.e. the front curve mold part) during the cure process and remain with the second mold part 102 after separation until the lens 100 has been released from the front curve mold part 102. In other embodiments, the lens 100 can adhere to the first mold part 101.

The lens 100 and the mold part to which it is adhered after demolding are contacted with an aqueous solution. The aqueous solution can be heated to any temperature below the boiling point of the aqueous solution. For example, in one embodiment, the aqueous solution may be raised to a temperature of between about 40° C. to about 80° C., and in another embodiment between about 30° C. and 70° C., and in yet another embodiment, between about 46 and about 65° C. Heating can be accomplished with a heat exchange unit to minimize the possibility of explosion, or by any other feasible means or apparatus for heating a liquid.

The aqueous solution is primarily water. In some embodiments, the aqueous solution is at least about 70 wt % water, and in other embodiments at least about 90 weight % water. The aqueous solution may also be a contact lens packaging solution. The aqueous solution may also include additives, such as Tween 80, which is polyoxyethylene sorbitan monooleate, Tyloxapol, octylphenoxy (oxyethylene) ethanol, amphoteric 10), preservatives (e.g. EDTA, sorbic acid, DYMED, chlorhexadine gluconate, hydrogen peroxide, thimerosal, polyquad, polyhexamethylene biguanide, antibacterial agents, lubricants, salts and buffers. In some embodiments, additives can be added to the hydration solution in amounts varying between 0.01% and 10% by weight, but cumulatively less than about 10% by weight.

Exposure of the ophthalmic lens 100 to the aqueous solution can be accomplished by any method, such as washing, spraying, soaking, submerging, or any combination of the aforementioned. For example, in some embodiments, the lens 100 can be washed with an aqueous solution comprising deionized water in a hydration tower.

In embodiments using a hydration tower, front curve mold parts 102 containing lenses 100 can be placed in pallets or trays and stacked vertically. The aqueous solution can be introduced at the top of the stack of lenses 100 so that the solution will flow downwardly over the lenses 100. The solution can also be introduced at various positions along the tower. In some embodiments, the trays can be moved upwardly allowing the lenses 100 to be exposed to increasingly fresher solution.

In other embodiments, the ophthalmic lenses 100 are soaked or submerged in the aqueous solution.

The contacting step can last from between about 2 minutes to about 400 minutes, in some embodiments from about 10 minutes to about 180 minutes, and in other embodiments from about 15 to about 30 minutes; however, the length of the contacting step depends upon the lens materials, including any additives, the materials that are used for the solutions or solvents, and the temperatures of the solutions. Sufficient treatment times typically shrink the contact lens, release the lens from the mold part.

In some preferred methods, after separation or demolding, the lenses on the front curves, which may be part of a frame, are mated with individual concave slotted cups to receive the contact lenses when they release from the front curves. The cups can be part of a tray. Examples can include trays with 32 lenses each, and 20 trays that can be accumulated into a magazine.

According to another embodiment of the present invention the lenses are submerged in the aqueous solution. In one embodiment, magazines can be accumulated and then lowered into tanks containing the aqueous solution. The aqueous solution may also include other additives as described above.

Modulus is measured by using the crosshead of a constant rate of movement type tensile testing machine equipped with a load cell that is lowered to the initial gauge height. A suitable testing machine includes an Instron model 1122. A dog-bone shaped sample having a 0.522 inch length, 0.276 inch “ear” width and 0.213 inch “neck” width is loaded into the grips and elongated at a constant rate of strain of 2 in/min. until it breaks. The initial gauge length of the sample (Lo) and sample length at break (Lf) are measured. Twelve specimens of each composition are measured and the average is reported. Tensile modulus is measured at the initial linear portion of the stress/strain curve.

The water content was measured as follows: lenses to be tested are allowed to sit in packing solution for 24 hours. Each of three test lens are removed from packing solution using a sponge tipped swab and placed on blotting wipes which have been dampened with packing solution Both sides of the lens are contacted with the wipe. Using tweezers, the test lens are placed in a weighing pan and weighed. The two more sets of samples are prepared and weighed as above pan is weighed three times and the average is the wet weight.

The dry weight is measured by placing the sample pans in a vacuum oven which has been preheated to 60° C. for 30 minutes. Vacuum is applied until at least 0.4 inches Hg is attained. The vacuum valve and pump are turned off and the lenses are dried for four hours. The purge valve is opened and the oven is allowed reach atmospheric pressure. The pans are removed and weighed. The water content is calculated as follows:

Wet weight=combined wet weight of pan and lenses−weight of weighing pan

Dry weight=combined dry weight of pan and lens−weight of weighing pan

$$\% water content = \frac{( wet weight - dry weight )}{wet weight} \times 100$$

The average and standard deviation of the water content are calculated for the samples are reported.

Oxygen permeability (Dk) may be determined by the polarographic method generally described in ISO 9913-1: 1996(E), but with the following variations. The measurement is conducted at an environment containing 2.1% oxygen. This environment is created by equipping the test chamber with nitrogen and air inputs set at the appropriate ratio, for example 1800 ml/min of nitrogen and 200 ml/min of air. The t/Dk is calculated using the adjusted p_{O2}. Borate buffered saline was used. The dark current was measured by using a pure humidified nitrogen environment instead of applying MMA lenses. The lenses were not blotted before measuring. Four lenses were stacked instead of using lenses of varied thickness. A curved sensor was used in place of a flat sensor. The resulting Dk value is reported in barrers.

The dynamic contact angle or DCA, typically at 23° C., with borate buffered saline, using a Wilhelmy balance. The wetting force between the lens surface and borate buffered saline is measured using a Wilhelmy microbalance while the sample strip cut from the center portion of the lens is being immersed into or pulled out of the saline at a rate of 100 microns/sec. The following equation is used

F=2γpcos θ or θ=cos⁻¹(F/2γp)

where F is the wetting force, y is the surface tension of the probe liquid, p is the perimeter of the sample at the meniscus and θ is the contact angle. Typically, two contact angles are obtained from a dynamic wetting experiment—advancing contact angle and receding contact angle. Advancing contact angle is obtained from the portion of the wetting experiment where the sample is being immersed into the probe liquid, and these are the values reported herein. At least four lenses of each composition are measured and the average is reported.

It will be appreciated that all of the tests specified herein have a certain amount of inherent test error. Accordingly, results reported herein are not to be taken as absolute numbers, but numerical ranges based upon the precision of the particular test.

In order to illustrate the invention the following examples are included. These examples do not limit the invention. They are meant only to suggest a method of practicing the invention. Those knowledgeable in contact lenses as well as other specialties may find other methods of practicing the invention. However, those methods are deemed to be within the scope of this invention.

### EXAMPLES

The following abbreviations are used in the examples below: Macromer Macromer prepared according to the procedure disclosed under Macromer Preparation in Example 1, of US-2003-0052424-A1
DMA N,N-dimethylacrylamide
HEMA 2-hydroxyethyl methacrylate
mPDMS monomethacryloxypropyl terminated mono-n-butyl terminated polydimethylsiloxane, manufactured by Gelest, molecular weight specified in the Examples
Norbloc 2-(2′-hydroxy-5-methacrylyloxyethylphenyl)-2H-benzotriazole
PVP poly(N-vinyl pyrrolidone) (K values noted)

Blue HEMA the reaction product of Reactive Blue 4 and HEMA, as described in Example 4 of U.S. Pat. No. 5,944,853
mPDMS-OH mono-(3-methacryloxy-2-hydroxypropyloxy)propyl terminated, mono-butyl terminated polydimethylsiloxane, made according to Example 29, molecular weight 612
TEGDMA tetraethyleneglycol dimethacrylate
EGDMA ethyleneglycol dimethacrylate
acPDMS bis-3-acryloxy-2-hydroxypropyloxypropyl polydimethylsiloxane (MW 1000 and 2000, acrylated polydimethylsiloxane) from Gelest and Degussa, respectively
maPDMS methacryloxypropyl terminated polydimethylsiloxane (MW 550-700) from Gelest
CGI 819 bis(2,4,6-trimethylbenzoyl)-phenylphosphineoxide

Throughout the Examples intensity is measured using an IL 1400A radiometer, using an XRL 140A sensor.

### Examples 1-10

### Manufacture of Contact Lenses

The monomer components listed in Table 1 (listed as weight percent, based upon all components excluding diluent) were mixed with t-amyl alcohol (weight %, based upon all components, including diluent) and degassed under vacuum (650(±100) mmHg, 25(±5)° C.) for 20(±5) minutes. Each reaction mixture was dosed into thermoplastic contact lenses molds (front curves made from Zeonor® obtained from Zeon, Corp. and back curves made from polypropylene) and irradiated using TL20W 03T lamps (approximately 1.5 to 3.0 mW/cm²) under a nitrogen atmosphere for 25(±5) minutes at 55(±5)° C. The resulting lenses were hand demolded and released by submerging lenses in the front curve (FC) molds in DI water at 90(±5)° C. for about 2 minutes. If lenses did not release from the FC mold at 2 minutes, lenses were maintained under the 90(±5)° C. DI water and squirted with same DI water using a disposable pipette. If lenses still failed to release from the FC, lenses were then manually swabbed from the FC. Lens release was rated on a scale of 1-3 where 1=full lens release, 2=lens required minor manipulation to release (e.g. pipetted water) and 3=lens did not release and required swabbing from the FC. Lenses were than transferred to jars and underwent two “change-out” steps—Step 1) DI water at 90(±5)° C. for a minimum of 30 minutes and Step 2) DI water at 25(±5)° C. for a minimum of 30 minutes. Lenses were then equilibrated in packing solution and inspected in packing solution. Lenses were packaged in vials containing 5 to 7 mL borate buffered saline solution, capped and sterilized at 120° C. for 30 minutes. Tables 1 and 2 include the formulations, lens properties and release properties, respectively. Where listed, lens diameters were measured at room temperature in packing solution.

TABLE 1
Reaction Mixture Formulations (wt %, unless otherwise noted)

| | Ex 1 | Ex 2 | Ex 3 | Ex 4 | Ex 5 | Ex 6 | Ex 7 | Ex 8 | Ex 9 | Ex 10 |
|---|---|---|---|---|---|---|---|---|---|---|
| DMA | 19.50 | 19.50 | 15.00 | 15.00 | 15.00 | 15.00 | 15.00 | 15.00 | 19.50 | 19.50 |
| HEMA | 8.03 | 8.03 | 12.53 | 12.53 | 12.53 | 12.53 | 12.53 | 12.53 | 8.03 | 8.03 |
| Norbloc | 2.20 | 2.20 | 2.20 | 2.20 | 2.20 | 2.20 | 2.20 | 2.20 | 2.20 | 2.20 |
| Blue HEMA | 0.02 | 0.02 | 0.02 | 0.02 | 0.02 | 0.02 | 0.02 | 0.02 | 0.02 | 0.02 |
| PVP K90 | 17 | 17 | 17 | 17 | 17 | 17 | 17 | 17 | 17 | 17 |
| CGI 819 | 0.25 | 0.25 | 0.25 | 0.25 | 0.25 | 0.25 | 0.25 | 0.25 | 0.25 | 0.25 |
| Macromer | 7.00 | 7.00 | 7.00 | 7.00 | 7.00 | 7.00 | 7.00 | 7.00 | 7.00 | 7.00 |
| OH-mPDMS | 44.00 | 42.00 | 45.25 | 44.50 | 44.00 | 43.00 | 42.00 | 40.00 | 44.00 | 42.00 |
| TEGDMA | 2.00 | 4.00 | 0.75 | 1.50 | 2.00 | 3.00 | 4.00 | 6.00 | 2.00 | 4.00 |
| TEGDMA (mol | 1.76 | 3.49 | 0.68 | 1.36 | 1.81 | 2.71 | 3.60 | 5.35 | 1.76 | 3.49 |
| %) | | | | | | | | | | |
| Diluent: | 45 | 45 | 50 | 50 | 50 | 50 | 50 | 50 | 55 | 55 |

TABLE 2
Lens Properties

| | Ex 1 | Ex 2 | Ex 3 | Ex 4 | Ex 5 |
|---|---|---|---|---|---|
| Diameter (mm) | 14.53(0.01) | 14.16(0.02) | 14.19(0.06) | 14.06(0.07) | 13.78(0.04) |
| Water Content (%) | 51.4(0.2) | 47.0(0.3) | 51.7(1.3) | 49.6(0.4) | 47.9(0.4) |
| Modulus (psi) | 111(9) | 151(9) | 78(7) | 105(11) | 120(6) |
| Release | 2 | 1 | 3 | 2 | 1 |
| | Ex 6 | Ex 7 | Ex 8 | Ex 9 | Ex 10 |
| Diameter (mm) | 13.69(0.04) | 13.62(0.13) | 13.26(0.02) | 14.09(0.06) | 13.65(0.11) |
| Water Content (%) | 47.3(0.6) | 45.1(0.7) | 44.8(1.1) | 56.0(0.5) | 51.5(0.2) |
| Modulus (psi) | 131(8) | 161(13) | 202(15) | 65(7) | 100(8) |
| Release | 1 | 1 | 1 | 2 | 1 |

Examples 1 and 2 have the same composition and diluent, except that the concentration of crosslinker for Example 2 is double that of Example 1 (4wt % instead of 2 wt %). In Examples 3-8, the crosslinker concentration is varied from 0.75 wt % to 6 wt % with a constant diluent concentration of 50 wt %. Examples 9 and 10 compare crosslinker concentrations of 2 and 4 wt %, at a diluent concentration of 55%. In each set of Examples, the release improves as crosslinker concentration increases.

### Examples 11-13

The procedure of Examples 1-10 was repeating using the monomer components listed in Table 3 (listed as weight percent, based upon all components excluding diluent). Lens properties and release results are listed in Table 4. Lens diameters were measured at room temperature in packing solution.

TABLE 3

| | Ex 11 | Ex 12 | Ex 13 |
|---|---|---|---|
| DMA | 15.00 | 15.00 | 15.00 |
| HEMA | 12.53 | 12.53 | 12.53 |
| Norbloc | 2.20 | 2.20 | 2.20 |
| Blue HEMA | 0.02 | 0.02 | 0.02 |
| PVP K90 | 17 | 17 | 17 |
| CGI 819 | 0.25 | 0.25 | 0.25 |
| Macromer | 7.00 | 7.00 | 7.00 |
| OH-mPDMS 612 | 43.00 | 43.00 | 43.00 |
| TEGDMA | 3.00 | 3.00 | 3.00 |
| Total Diluent: | 45 | 50 | 55 |

TABLE 4

| Lens | | | |
|---|---|---|---|
| Fabrication: | Ex 11 | Ex 12 | Ex 13 |
| Diameter (mm) | 13.94(0.03) | 13.69(0.04) | 13.42(0.04) |
| Water (%) | 44.6(0.4) | 47.3(0.6) | 48.6(0.3) |
| Modulus(psi) | 171(11) | 131(8) | 121(10) |
| Release | 2 | 1 | 1 |

### Examples 14-25

Contact lenses were made using the crosslinkers and crosslinker concentrations as shown in Table 5, below, with the following formulation: 46 weight % HO-mPDMS, 7 weight % Macromer, 15 wt % DMA, 12.53 wt % HEMA, 17 wt % PVP, 0.25 wt % CGI 819, 2.2 wt % Norbloc and 0.02 wt % Blue HEMA and 45 wt % of a 7:1 mixture of t-amyl alcohol/PVP k-12, and the process described in Example 1. The lenses were released as described in Example 1. The release results are shown in the last column of Table 5.

TABLE 5

| Ex. # | Xlinker | [xlinker] wt % | [xlinker] mol % | Release rating |
|---|---|---|---|---|
| 14 | EGDMA | 1 | 1.51 | 3 |
| 15 | EGDMA | 2 | 2.99 | 1 |
| 16 | EGDMA | 3 | 4.45 | 1 |
| 17 | EGDMA | 5 | 7.26 | 1 |
| 18 | TEGDMA | 3 | 2.72 | 2 |
| 19 | TEGDMA | 5 | 4.49 | 1 |
| 20 | acPDMS | 5 | 1.53 | 2 |
| | 1000 | | | |
| 21 | acPDMS | 10 | 3.09 | 1 |
| | 1000 | | | |
| 22 | acPDMS | 5 | 0.77 | 3 |
| | 2000 | | | |
| 23 | acPDMS | 10 | 1.57 | 3 |
| | 2000 | | | |
| 24 | acPDMS | 15 | 2.39 | 1 |
| | 2000 | | | |

### Examples 26-28

The reaction mixture shown in Table 6 for Example 26 was degassed and cured according to the procedure of Examples 1-10. The reaction mixtures for Examples 27 and 28 were degassed under vacuum (20(±2) mmHg, 25(±3)° C., 127(±3)rpm) for 15(±3) minutes. The reaction mixture was dosed into thermoplastic contact lenses molds, weights were placed on the molds for 10 seconds and then the molds were cured at 80° C., under a nitrogen atmosphere, with an irradiation of 1.5 mW/cm² for 2 minutes followed by 6.0 mW/cm² for 6 minutes (Philips High Intensity Bulbs: M2-B1-10) for a period of 8 minutes. The resulting lenses were demolded and released by submerging lenses in DI water at 90(±5)° C. for 10(±2) minutes and then manually swabbing lenses from the front curve. Lenses were than transferred to hydration trays and were placed in a staging tank of DI water at 45(≅10)° C. for a minimum of 30 minutes. Lenses were equilibrated in packing solution and inspected in packing solution. Lenses were packaged in vials containing 7 mL borate buffered saline and sterilized at 120° C. for about 20 minutes. Lens properties are listed in Table 7.

TABLE 6

| | Ex 26 | Ex 27 | Ex 28 |
|---|---|---|---|
| DMA | 27.00 | 27.00 | 27.00 |
| HEMA | 6.53 | 6.53 | 6.53 |
| Norbloc | 2.20 | 2.20 | 2.20 |
| Blue HEMA | 0.02 | 0.02 | 0.02 |
| PVP K90 | 8.00 | 8.00 | 8.00 |
| CGI 819 | 0.25 | 0.25 | 0.25 |
| Macromer | 19.00 | 19.00 | 19.00 |
| acPDMS | 3.00 | 3.00 | 3.00 |
| mPDMS 1000 | 34.00 | N/A | 17.00 |
| mPDMS 700 | N/A | 34.00 | 17.00 |
| Total Monomer: | 55 | 55 | 55 |
| Diluent | | | |
| t-Amyl Alcohol | 87.5 | 87.5 | 87.5 |
| 1,2-Octanediol | 12.5 | 12.5 | 12.5 |
| Total Diluent: | 45 | 45 | 45 |

TABLE 7

| Lens Properties: | Ex. 26 | Ex. 27 | Ex. 28 |
|---|---|---|---|
| Water Content(%) | 47 | 45 | 44 |
| Modulus(psi) | 69(7) | 93(5) | 109(9) |
| Dk (edge corrected) | 114 | 107 | 125 |
| Contact angle (°) | 63(3) | 57(2) | 61(5) |
| Release | swab | <1 min | <2 min |

### Example 29

To a stirred solution of 45.5 kg of 3-allyloxy-2-hydroxypropane methacrylate (AHM) and 3.4 g of butylated hydroxy toluene (BHT) was added 10 ml of Pt (0) divinyltetramethyldisiloxane solution in xylenes (2.25% Pt concentration) followed by addition of 44.9 kg of n-butylpolydimethylsilane. The reaction exotherm was controlled to maintain reaction temperature of about 20° C. After complete consumption of n-butylpolydimethylsilane, the Pt catalyst was deactivated by addition of 6.9 g of diethylethylenediamine. The crude reaction mixture was extracted several times with 181 kg of ethylene glycol until residual AHM content of the raffinate was <0.1%. 10 g of BHT was added to the resulting raffinate, stirred until dissolution, followed by removal of residual ethylene glycol affording 64.5 kg of the OH-mPDMS. 6.45 g of 4-Methoxy phenol (MeHQ) was added to the resulting liquid, stirred, and filtered yielding 64.39 kg of final OH-mPDMS as colorless oil.

We claim

1. A method comprising
(a) curing a reactive mixture comprising at least one silicone containing component and at least one shrinkage agent in a mold to form a cured article;
(b) contacting the cured article in the mold with an aqueous solution under conditions which shrink the cured article; and
(c) optionally removing the cured article from the mold.

2. The method of claim 1 wherein said shrinkage agent comprises at least one monofunctional low molecular weight linear silicone.

3. The method of claim 2 wherein said linear silicone has a molecular weight less than about 1000.

4. The method of claim 2 wherein said linear silicone has a molecular weight less than about 800.

5. The method of claim 2 wherein said linear silicone has a molecular weight less than about 700.

6. The method of claim 2 wherein said linear silicone comprises at least one siloxane group.

7. The method of claim 2 wherein said linear silicone comprises at least one polydimethylsiloxane.

8. The method of claim 2 wherein said linear silicone is selected from the group consisting of monomethacryloxypropyl terminated mono-n-butyl terminated polydimethylsiloxanes, 2-methyl-,2-hydroxy-3-[3-[1,3,3,3-tetramethyl-1-[(trimethylsilyl)oxy]disiloxanyl]propoxy]propyl ester, 2-hydroxy-3-methacryloxypropyloxypropyl-tris(trimethylsiloxy)silane, 3-methacryloxypropyltris(trimethylsiloxy)silane, 3-methacryloxypropylbis(trimethylsiloxy)methylsilane and 3-methacryloxypropylpentamethyl disiloxane, mono-(3-methacryloxy-2-hydroxypropyloxy)propyl terminated, mono-butyl terminated polydimethylsiloxane, silicone containing methacrylamides, and combinations thereof.

9. The method of claim 2 wherein at least about 10 weight % of said at least one silicone containing component is replaced with said at least one monofunctional low molecular weight silicone.

10. The method of claim 2 wherein between about 20 and 100 weight % of said at least one silicone containing component is replaced with said at least one monofunctional low molecular weight silicone.

11. The method of claim 2 wherein between about 40 and 100 weight % of of said at least one silicone containing component is replaced with said at least one monofunctional low molecular weight silicone.

12. The method of claim 1 wherein said shrinkage agent comprises at least one crosslinking compound in an amount of at least about 2 mole %.

13. The method of claim 1 wherein said shrinkage agent comprises at least one crosslinking compound in an amount of at least about 2.5 mole %.

14. The method of claim 12 wherein said crosslinking compound is selected from the group consisting of hydrophilic crosslinkers and hydrophobic crosslinkers.

15. The method of claim 12 wherein said shrink agent comprises a hydrophilic crosslinking compound selected from the group consisting of tetraethyleneglycol dimethacrylate, triethyleneglycol dimethacrylate, ethyleneglycol dimethacylate, ethylenediamine dimethyacrylamide, glycerol dimethacrylate and combinations thereof.

16. The method of claim 12 wherein said shrink agent comprises a hydrophobic crosslinking compound selected from the group consisting of acryloxypropyl terminated polydimethylsiloxane (n=10 or 20), hydroxylacrylate functionalized siloxane macromer, methacryloxypropyl terminated PDMS, butanediol dimethacrylate, divinyl benzene, 1,3-bis(3-methacryloxypropyl)tetrakis(trimethylsiloxy) disiloxane and mixtures thereof.

17. The method of claim 12 wherein said shrink agent comprises a crosslinking compound selected from the group consisting of tetraethyleneglycol dimethacrylate, ethyleneglycol dimethacylate, acryloxypropyl terminated polydimethylsiloxane (n=10 or 20), and combinations thereof.

18. The method of claim 1 wherein said reactive mixture further comprises at least one diluent in an amount from about 40 to about 60 weight % based upon the weight of the diluent and components in the reactive mixture.

19. The method of any of claim 18 wherein said diluent is present in an amount from about 50 to about 60 weight % based upon the weight of the diluent and components in the reactive mixture.

20. The method of claim 1 wherein said contacting conditions include a temperature of at least about 80° C.

21. The method of claim 1 wherein said contacting conditions include a temperature of at least about 90° C.

22. The method of claim 1 wherein said shrinkage agent comprises at least one water content decreasing compound.

23. The method of claims 1 wherein said reaction mixture further comprises at least one hydrophilic monomer.

24. The method of claim 23 wherein said hydrophilic monomer is present in an amount between about 5 and 50 weight %.

25. The method of claim 23 wherein said hydrophilic monomer is present in an amount between about 20 and 50 weight %.

26. The method of claim 23 wherein said aqueous solution comprises at least about 70 wt % water.

27. The method of claim 23 wherein said aqueous solution comprises at least about 90 wt % water.

28. The method of claim 1 wherein said contact lens shrinks at least about 3% in contacting step (b).

29. The method of claim 1 wherein said contact lens shrinks at least about 5% in contacting step (b).

30. The method of claim 1 wherein said contact lens shrinks at least about 7% in contacting step (b).

31. A method comprising
(a) curing in a mold to form a silicone hydrogel contact lens, a reaction mixture comprising at least one reactive silicone component and at least about 40 weight % diluent based upon all components in the reaction mixture;
(b) contacting the contact lens with an aqueous solution in the mold under conditions which shrink the contact lens; and
(c) optionally removing the contact lens from the mold.

32. The method of claim 31 wherein said reaction mixture further comprises at least one shrink agent.

33. The method of claim 32 wherein said shrinkage agent comprises at least one monofunctional low molecular weight linear silicone.

34. The method of claim 33 wherein said linear silicone has a molecular weight less than about 1000.

35. The method of claim 33 wherein said linear silicone comprises at least one siloxane group.

36. The method of claim 33 wherein said linear silicone comprises at least one polydimethylsiloxane.

37. The method of claim 33 wherein said linear silicone is selected from the group consisting of monomethacryloxypropyl terminated mono-n-butyl terminated polydimethylsiloxanes, 2-methyl-,2-hydroxy-3-[3-[1,3,3,3-tetramethyl-1-[(trimethylsilyl)oxy]disiloxanyl]propoxy]propyl ester, 2-hydroxy-3-methacryloxypropyloxypropyl-tris(trimethylsiloxy)silane, 3-methacryloxypropyltris(trimethylsiloxy)silane, 3-methacryloxypropylbis(trimethylsiloxy)methylsilane and 3-methacryloxypropylpentamethyl disiloxane, mono-(3-methacryloxy-2-hydroxypropyloxy)propyl terminated, mono-butyl terminated polydimethylsiloxane, silicone containing methacrylamides, and combinations thereof.

38. The method of claim 32 wherein said shrinkage agent comprises at least one crosslinking compound in an amount of at least about 2 mole %.

39. The method of claim 38 wherein said crosslinking compound is selected from the group consisting of hydrophilic crosslinkers and hydrophobic crosslinkers.

40. The method of claim 38 wherein said crosslinking compound is selected from the group consisting of tetraethyleneglycol dimethacrylate, ethyleneglycol dimethacylate, acryloxypropyl terminated polydimethylsiloxane (n=10 or 20), and combinations thereof.

41. The method of claim 31 wherein said diluent is present in an amount from about 40 to about 60 weight % based upon the weight of the diluent and components in the reactive mixture.

42. The method of claim 31 wherein said diluent is present in an amount from about 45 to about 60 weight % based upon the weight of the diluent and components in the reactive mixture.

43. The method of claim 31 wherein said diluent is present in an amount from about 50 to about 60 weight % based upon the weight of the diluent and components in the reactive mixture

44. The method of claim 31 wherein said contacting conditions include a temperature of at least about 80° C.

45. The method of claim 32 wherein said shrinkage agent comprises at least one water content decreasing compound.

46. The method of claims 31 wherein said reaction mixture further comprises at least one hydrophilic monomer.

47. The method of claim 31 wherein said aqueous solution comprises at least about 70 wt % water.

48. The method of claim 31 wherein said contact lens shrinks at least about 3% in contacting step (b).

49. The method of claim 31 wherein said contact lens shrinks at least about 3% in contacting step (b).

50. The method of claim 31 wherein said contact lens shrinks at least about 7% in contacting step (b).
